(19) United States
(12) Patent Application Publication
(10) Pub. No.: US 2006/0226796 A1
(43) Pub. Date: Oct. 12, 2006

(54) High-voltage discharge lamps parallel and driving arrangement

(76) Inventor: Hui-Chuan Chuang, Tainan Hsien (TW)

Correspondence Address: PRO-TECTOR INTERNATIONAL SERVICES, 20775 NORADA CT., SARATOGA, CA, 95070, US

(21) Appl. No.: 11/104,966

(22) Filed: Apr. 12, 2005

(51) Int. Cl. H05B 37/00

(52) U.S. Cl. 315/312

(57) ABSTRACT

A high-voltage discharge lamps parallel and driving arrangement includes a first and a second high-voltage discharge lamp bank having a plurality of parallelly connected high-voltage discharge lamps each, and being electrically connected to a first and a second output at a secondary side of a transformer, respectively. A primary side of the transformer is connected to a driving circuit. The lamps are allowed to charge and discharge directly without any current-limiting capacitance. Since the first and the second high-voltage discharge lamp bank are electrically connected to the outputs of a common transformer, the number of transformers used could be reduced to allow increased volume of the transformer, and easy production at high good yield and reduced manufacturing cost.

### FIELD OF THE INVENTION

The present invention relates to a high-voltage discharge lamps parallel and driving arrangement, and more particularly to a low-cost, high-quality, and multi-application high-voltage discharge lamp circuit for use with a backlighting panel of a large-size liquid crystal display (LCD), such as an LCD-TV, to drive a plurality of high-voltage discharge lamps.

### BACKGROUND OF THE INVENTION

The rapidly developed technologies effectively upgrade people's living standards, help people to efficiently pursue high living quality, and contribute to many times of industrial revolutions. Among others, television set with liquid crystal display (LCD-TV) and plasma TV have now gradually replaced the conventional TV and become the main stream in people's audio-visual world.

LCD-TV includes a backlighting panel that must use many cold cathode tubes. The cold cathode tube is a type of discharge lamp. In the backlighting panel of the conventional LCD-TV, since each piece of such high-voltage discharge lamp requires a driving circuit, it requires very high cost to manufacture the backlighting panel.

FIG. 1 is a circuit diagram for a conventional backlighting panel for an LCD-TV. As shown, a rectifying capacitance is provided between each high-voltage discharge lamp and a transformer, and a plurality of high-voltage discharge lamps are parallelly connected and lightened. This arrangement has the advantages of using only one driving circuit and accordingly, requiring lower cost. However, since there is not only an overly high potential difference existed between the high-voltage discharge lamps, but also a phase shift, the lamps have poor current uniformity and are seriously mutually interfered with one another. Moreover, light from the lamps flutters significantly when the lamps are relatively long in length.

FIG. 2 shows another arrangement for the conventional backlighting panel for an LCD-TV. In this arrangement, each piece of high-voltage discharge lamp is connected to a leakage flux transformer, and a plurality of high-voltage discharge lamps are parallelly connected and lightened. This arrangement is a workable solution in terms of the quality, the safety in use, and the full light beam efficiency with respect to electric power of the backlighting panel. However, there are too many transformers used in the circuit to make the production of the backlighting panel difficult and result in reduced good yield and production speed, and accordingly, increased manufacturing cost. Due to the overly high manufacturing cost, the backlighting panel with the circuit shown in FIG. 2 fails to replace the backlighting panel with the circuit shown in FIG. 1.

It is therefore an important issue to overcome the problems existed in the conventional backlighting panels for LCD-TV.

### SUMMARY OF THE INVENTION

A primary object of the present invention is to provide a high-voltage discharge lamps parallel and driving arrangement that effectively eliminates the drawback of high manufacturing cost due to the use of one leakage flux transformer for each piece of high-voltage discharge lamp as shown in FIG. 2, and thereby reduces the number of transformers used to allow increased volume of the transformer, easy production of the backlighting panel at high good yield and reduced manufacturing cost.

Another object of the present invention is to provide a high-voltage discharge lamps parallel and driving arrangement, in which discharge lamps are allowed to directly charge and discharge in order to replace a current-limiting capacitance, so that current between the lamps is highly uniform, mutual interference between lamps is reduced, and uneven brightness is avoided to produce a backlighting panel having further improved quality, safety for use, and full light beam efficiency with respect to electric power.

To achieve the above and other objects, the high-voltage discharge lamps parallel and driving arrangement according to the present invention for use with the backlighting panel of a large-size LCD to drive a plurality of high-voltage discharge lamps includes at least a first high-voltage discharge lamp bank having a plurality of parallelly connected high-voltage discharge lamps, a second high-voltage discharge lamp bank having a plurality of parallelly connected high-voltage discharge lamps, a transformer being electrically connected at two outputs at a secondary side thereof to the first and the second high-voltage discharge lamp bank, respectively, and a driving circuit including two transistors electrically connected to two inputs (1^{st} and 3^{rd} pins) at a primary side of the transformer, respectively.

The first output (4^{th} pin) at the secondary side of the transformer is electrically connected to the parallelly connected high-voltage discharge lamps of the first high-voltage discharge lamp bank, and the second output (5^{th} pin) at the secondary side of the transformer is electrically connected to the parallelly connected high-voltage discharge lamps of the second high-voltage discharge lamp bank. In this manner, the number of transformers used is reduced to thereby reduce the manufacturing cost, and the high-voltage discharge lamps in the same bank may have the same voltage. As a result, the potential difference is minimized without phase shift, the lamps have highly uniform current, and the mutual interference between lamps is lowered.

The two inputs (1^{st} and 3^{rd} pins) at the primary side of the transformer are separately electrically connected to the collectors of the two transistors of the driving circuit, and the two transistors of the driving circuit are connected at their respective base to a modulation circuit, via which the two transistors may be directly controlled to have fixed working frequency without being influenced by the resonance of the transformer, the output current of the driving circuit may be largely changed, and the frequency may be changed according to actual need without changing the component values.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a circuit diagram of a conventional high-voltage discharge lamps parallel and driving arrangement;

FIG. 2 is a circuit diagram of another conventional high-voltage discharge lamps parallel and driving arrangement;

FIG. 3 is a circuit diagram of a high-voltage discharge lamps parallel and driving arrangement according to a preferred embodiment of the present invention;

FIG. 4 is a circuit diagram of a high-voltage discharge lamps parallel and driving arrangement according to a second embodiment of the present invention;

FIG. 5 is a circuit diagram showing a first example of grounding the high-voltage discharge lamps of the present invention;

FIG. 6 is a circuit diagram showing a second example of grounding the high-voltage discharge lamps of the present invention; and

FIG. 7 is a circuit diagram showing a third example of grounding the high-voltage discharge lamps of the present invention.

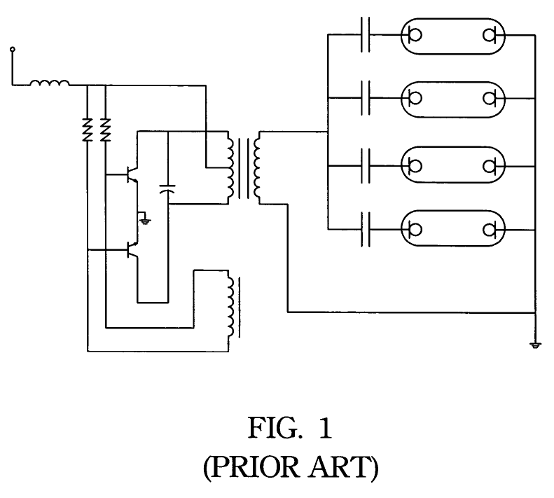

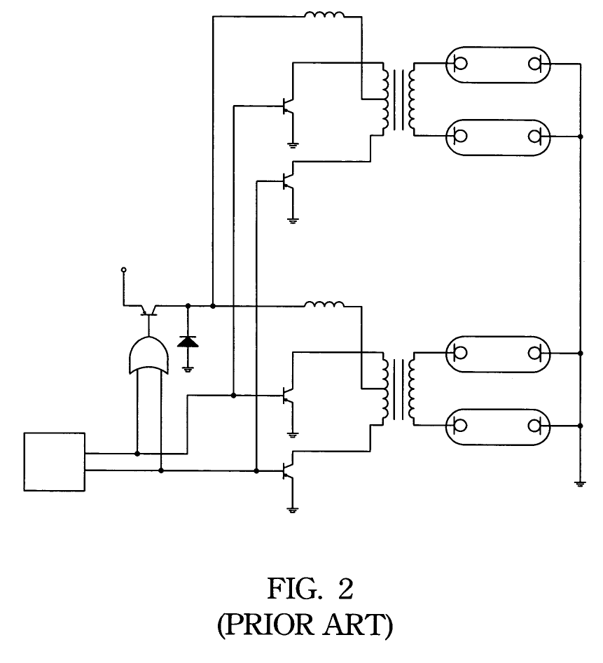

### DETAILED DESCRIPTION OF THE PREFERRED EMBODIMENTS

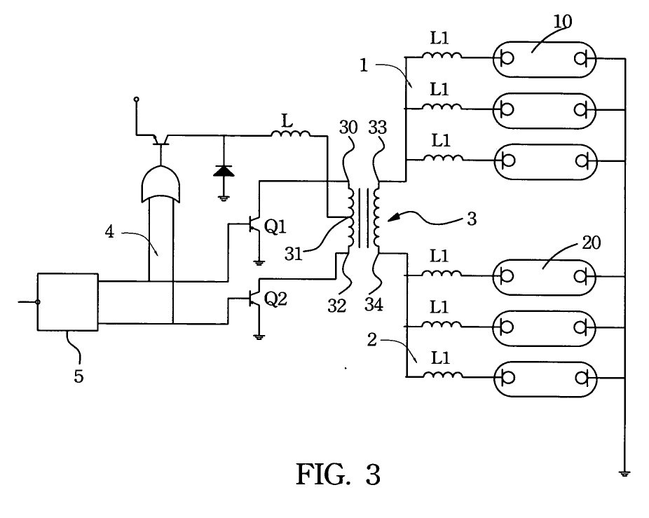

Please refer to FIG. 3 that is a circuit diagram of a high-voltage discharge lamps parallel and driving arrangement according to a preferred embodiment of the present invention. As shown, in the preferred embodiment of the present invention, there is included a first high-voltage discharge lamp bank 1, a second high-voltage discharge lamp bank 2, a transformer 3, and a driving circuit 4.

The first high-voltage discharge lamp bank 1 is electrically connected to a first output 33 of the transformer 3, and includes a plurality of high-voltage discharge lamps 10, which are connected to the first output 33 of the transformer 3 in parallel and therefore have the same potential difference without phase shift, enabling the high-voltage discharge lamps 10 to have highly uniform current and reduced mutual interference between the lamps.

The second high-voltage discharge lamp bank 2 is electrically connected to a second output 34 of the transformer 3, and includes a plurality of high-voltage discharge lamps 20, which are connected to the second output 34 of the transformer 3 in parallel to provide the same function as the first high-voltage discharge lamp bank 1.

The transformer 3 has a first input 30 electrically connected a first transistor Q1, a second input 31 electrically connected to a buffer inductance L, and a third input 32 electrically connected to a second transistor Q2. The above-mentioned first and second outputs 33, 34 are located at a secondary side of the transformer 3 and electrically connected to the first and the second high-voltage discharge lamp bank 1, 2, respectively. Since the first and the second high-voltage discharge lamp bank 1, 2 have a common transformer 3, the number of transformers 3 used in the present invention is reduced. As a result, transformers 3 having an increased volume could be used to make the production of the present invention easier with increased good yield and accordingly, at reduced manufacturing cost.

The driving circuit 4 includes the above-mentioned first and second transistor Q1, Q2, and buffer inductance L. The first transistor Q1 is electrically connected at a collector to the first input 30 of the transformer 3, the second transistor Q2 is electrically connected at a collector to the third input 32 of the transformer 3, and the first and the second transistor Q1, Q2 are electrically connected at their respective base to a modulation circuit 5. Through direct control via the modulation circuit 5, the first and the second transistor Q1, Q2 may have fixed working frequency without being influenced by the resonance of the transformer 3; moreover, it is possible to largely change the output current of the driving circuit 4 and to change the frequency according to actual need without the need of changing the component value thereof. The buffer inductance L of the driving circuit 4 is electrically connected to the second input 31 of the transformer 3.

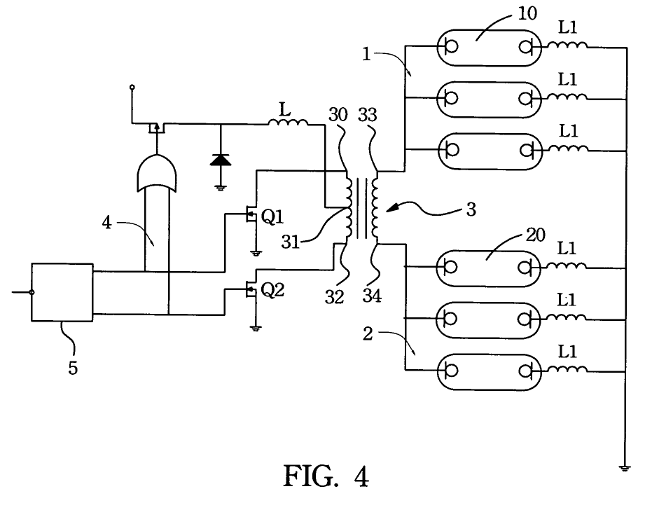

Please refer to FIG. 4, which is a circuit diagram of another embodiment of the present invention, and to FIG. 3 at the same time. The transistors Q1, Q2 used in the present invention may be of any type, such as a field effect transistor (FET).

In either embodiment, the high-voltage discharge lamps 10, 20 are connected in series to an inductance L1 each for the purpose of balancing. The inductance L1 may be serially connected between each high-voltage discharge lamp 10, 20 and a corresponding output of the transformer 3, as in the preferred embodiment shown in FIG. 3, or between each high-voltage discharge lamp 10, 20 and a ground, as in the second embodiment shown in FIG. 4.

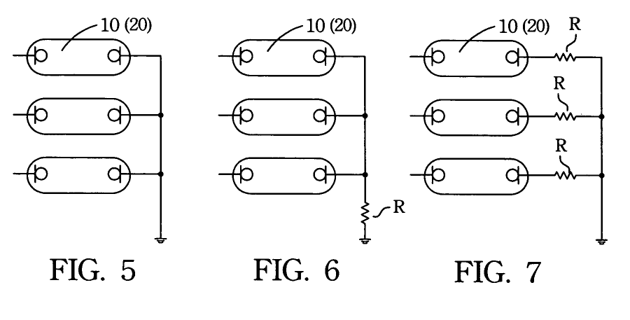

The high-voltage discharge lamps 10, 20 may be grounded in different manners. In FIG. 5, the high-voltage discharge lamps are connected in parallel and then directly grounded; in FIG. 6, the high-voltage discharge lamps are parallelly connected to one another and then serially connected to a resistor R before being grounded; and in FIG. 7, the high-voltage discharge lamps are serially connected to a resistor R each and then parallelly connected to one another before being grounded. The resistors R are for the purpose of protection and detection in the present invention.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A high-voltage discharge lamps parallel and driving arrangement, comprising a first high-voltage discharge lamp bank, a second high-voltage discharge lamp bank, a transformer, and a driving circuit:
said first high-voltage discharge lamp bank including a plurality of high-voltage discharge lamps, which are connected to one another in parallel and then electrically connected to a first output at a secondary side of said transformer;
said second high-voltage discharge lamp bank including a plurality of high-voltage discharge lamps, which are connected to one another in parallel and then electrically connected to a second output at the secondary side of said transformer;
said transformer including a first input, a second input, and a third input at a primary side thereof, and a first output and a second output at a secondary side thereof; said first and said second output being electrically connected to said first and said second high-voltage discharge lamp bank, respectively; and
said driving circuit including a first transistor, a second transistor, and a buffer inductance; said first and said second transistor being electrically connected at respective collector to said first and said third input at the primary side of said transformer, respectively, and at respective base to a modulation circuit; and said buffer inductance being connected to said second input at the primary side of said transformer.

2. The high-voltage discharge lamps parallel and driving arrangement as claimed in claim 1, wherein said first and said second transistor may be a transistor of any type, including a field effect transistor (FET).

3. The high-voltage discharge lamps parallel and driving arrangement as claimed in claim 1, wherein said high-voltage discharge lamps are serially connected to an inductance each.

4. The high-voltage discharge lamps parallel and driving arrangement as claimed in claim 1, wherein said high-voltage discharge lamps are parallelly connected to one another and then directly grounded.

5. The high-voltage discharge lamps parallel and driving arrangement as claimed in claim 1, wherein said high-voltage discharge lamps are parallelly connected to one another and then serially connected to a common resistor before being grounded.

6. The high-voltage discharge lamps parallel and driving arrangement as claimed in claim 1, wherein said high-voltage discharge lamps are serially connected to a resistor each and then parallelly connected to one another before being grounded.
